(19) United States
(12) Patent Application Publication
(10) Pub. No.: US 2022/0282524 A1
(43) Pub. Date: Sep. 8, 2022

(54) SCREEN DOOR CROSS BAR LATCH OPENER

(71) Applicant: Lippert Components, Inc., Elkhart, IN (US)

(72) Inventors: David CROWDER, Osceola, IN (US); Scott C. MCKINNON, Union City, MI (US)

(21) Appl. No.: 17/679,338

(22) Filed: Feb. 24, 2022

Related U.S. Application Data
(60) Provisional application No. 63/157,192, filed on Mar. 5, 2021.

(51) Int. Cl. E05B 1/00; E05C 1/14

(52) U.S. Cl. CPC E05B 1/0053; E05C 1/14

(57) ABSTRACT

A screen door cross bar is cooperable with a screen door assembly including a door frame and a latch assembly with a latch handle. The screen door cross bar includes a mounting bracket securable to the door frame on a side of the door frame opposite from the latch assembly, and a bar pivotally attached at one end to the mounting bracket. The bar is configured to engage the latch handle at an opposite end. The cross bar is designed to be fixed at a pivot point on the non-latch side of the screen door and receive the latch at the latch-side of the door to pivot and move vertically with the latch as it is actuated.

### CROSS-REFERENCES TO RELATED APPLICATIONS

This application claims the benefit of U.S. Provisional Patent Application No. 63/157,192, filed Mar. 5, 2021, the entire content of which is herein incorporated by reference.

### STATEMENT REGARDING FEDERALLY SPONSORED RESEARCH OR DEVELOPMENT

(NOT APPLICABLE)

### BACKGROUND

Recreational vehicles (RVs) including motor homes, camping trailers and the like are typically provided with a primary door at a side entrance. A screen door may be cooperable with the primary door, where both doors can be opened together or independently of each other. Both doors are pivotally hinged for movement between open and closed positions relative to the entrance opening of the RV. The screen door can be attached to the main door so that the doors move together, and the screen door can be detached from the main door so that the main door can be held open while the screen door is closed. The screen door provides a breezeway while preventing insects and other environmental elements from entering the RV.

Crossbars have been added to screen doors to prevent users from pushing on the screen or other breakable parts of the screen door while trying to exit.

### SUMMARY

It would be desirable to provide a crossbar that functions to prevent users from damaging the screen or other breakable parts of the screen door while also actuating the door latch of the screen door. A screen door crossbar according to exemplary embodiments is designed to be fixed at a pivot point on the non-latch side of the screen door and receive the latch at the latch-side of the door to pivot and move vertically with the latch as it is actuated. A line or other marker may be included on the door latch that will come with the product to indicate how far the latch receiver end of the crossbar should reach on the door latch for optimal fit and movement. The spring tension in the screen door latch moves the latch side of the crossbar vertically and returns the crossbar to a resting position.

In an exemplary embodiment, a screen door cross bar is cooperable with a screen door assembly including a door frame and a latch assembly with a latch handle. The screen door cross bar includes a mounting bracket securable to the door frame on a side of the door frame opposite from the latch assembly, a first receiver pivotally attached to the mounting bracket, a bar connected to the first receiver, and a second receiver connected to the bar. The second receiver is configured to engage the latch handle.

At least one of the first receiver and the second receiver may be selectively positionable relative to the bar to adjust a length of the screen door cross bar. In this context, the at least one of the first receiver and the second receiver may be secured to the bar with a screw.

The second receiver may include a latch handle channel that may be configured to receive the latch handle. In this context, the second receiver may be constructed of molded plastic, and the latch handle channel may be an integral part of the second receiver.

The mounting bracket may include a mounting plate with openings therein to receive a connector and a tab channel coupled with the mounting plate. In this context, the first receiver may include a tab member that is pivotally engageable with the tab channel. The tab member may be at least partially circular, and the tab channel may define an at least part-circular receiving channel.

The screen door cross bar may also include a replacement latch handle that is sized for cooperation with the second receiver.

In another exemplary embodiment, a screen door cross bar includes a mounting bracket securable to the door frame on a side of the door frame opposite from the latch assembly, and a bar pivotally attached at one end to the mounting bracket, where the bar is configured to engage the latch handle at an opposite end.

In yet another exemplary embodiment, a screen door assembly includes a door frame, a screen material secured in the door frame, a latch assembly including a latch handle, and the screen door cross bar of the described embodiments.

In still another exemplary embodiment, a method of installing a screen door cross bar on a screen door assembly with a door frame and a latch assembly with a latch handle includes the steps of (a) securing a mounting bracket to the door frame on a side of the door frame opposite from the latch assembly; (b) engaging a handle end of a bar with the latch handle; and (c) pivotally connecting a pivot end of the bar to the mounting bracket. The screen door cross bar may further include a first receiver connected to the pivot end of the bar and a second receiver connected to the latch end of the bar, where the method may further include a step of adjusting a length of the screen door cross bar by selectively positioning at least one of the first receiver and the second receiver on the bar.

### BRIEF DESCRIPTION OF THE DRAWINGS

These and other aspects and advantages will be described in detail with reference to the accompanying drawings, in which:

FIG. 1 shows an RV door with a mounted screen door connected to the RV door;

FIG. 2 shows the RV door with the screen door detached from the RV door;

FIGS. 3 and 4 are isometric views of the screen door crossbar;

FIG. 5 shows a latch handle associated with the screen door;

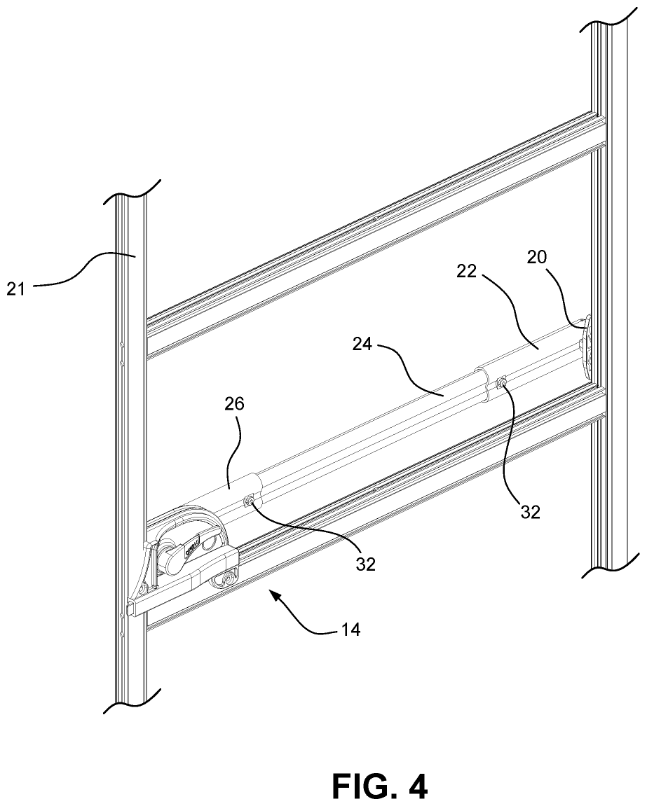

FIG. 6 shows a mounting bracket to which the bar of the screen door crossbar is pivotally mounted; and

FIGS. 7A and 7B show parts of the screen door crossbar.

### DETAILED DESCRIPTION

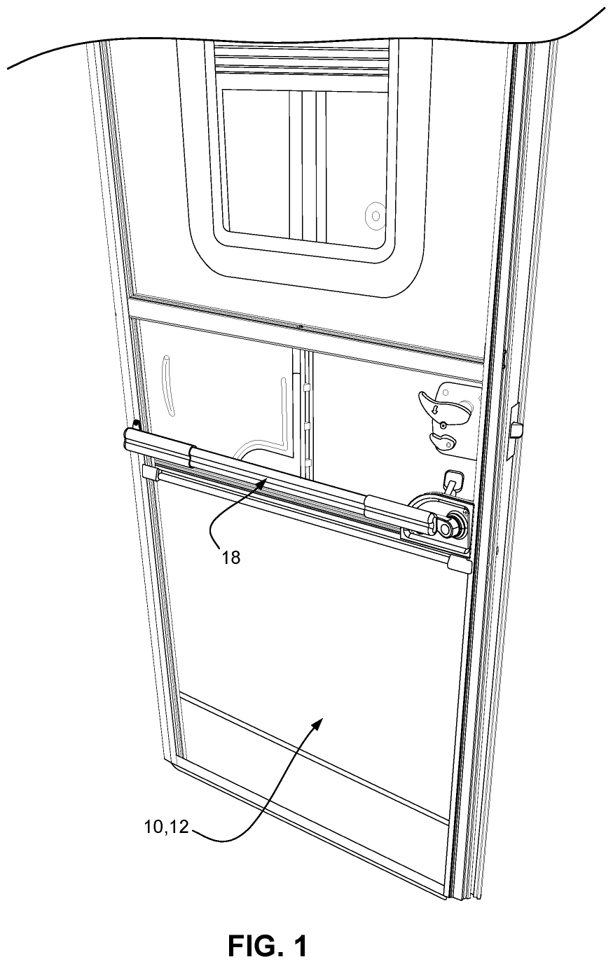

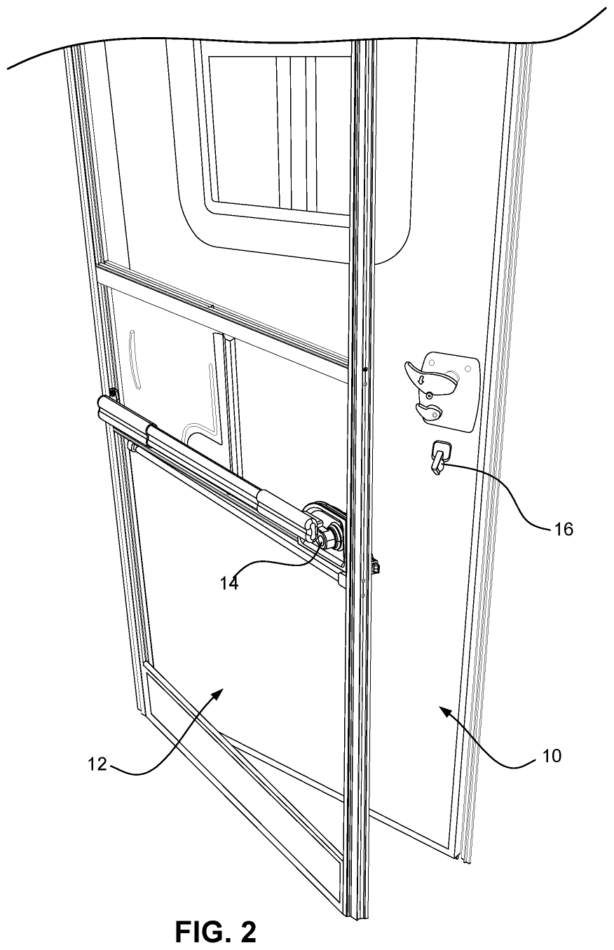

FIGS. 1 and 2 show an RV door 10 including a screen door assembly 12. In FIG. 1, the screen door assembly 12 is connected to the RV door 10 for pivoting with the RV door 10. In FIG. 2, the screen door assembly 12 is separated from the RV door 10 for closing the RV entrance with the RV door 10 held in an open position. In some embodiments, the screen door assembly 12 is provided with a latch assembly 14 that is selectively securable to a corresponding latch receiver 16 on the RV door 10.

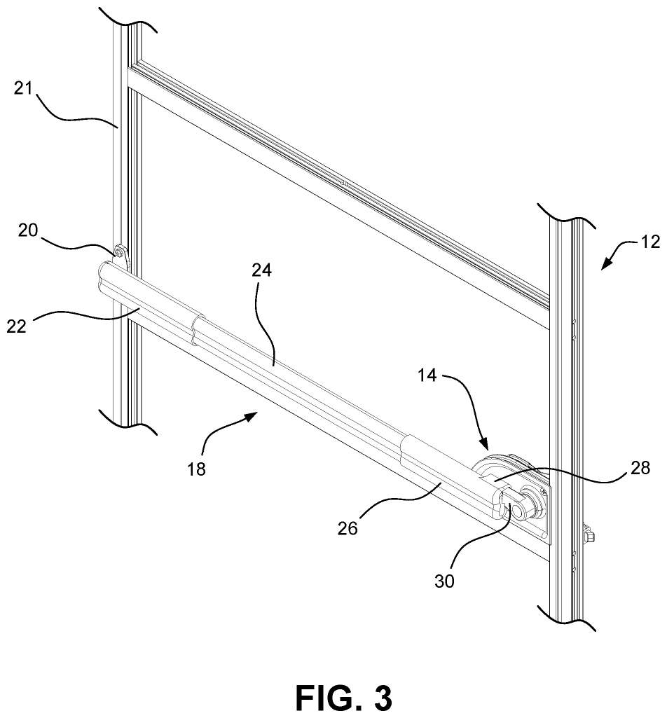

With reference to FIGS. 3 and 4, the screen door crossbar 18 is cooperable with the screen door assembly 12 to serve as a push bar and latch opener for the screen door assembly 12. The screen door crossbar 18 includes a mounting bracket 20 securable to the door frame 21 on a side of the door frame 21 opposite from the latch assembly 14. A first receiver 22 is pivotally attached to the mounting bracket 20, and a bar 24 is connected to the first receiver 22. A second receiver 26 is connected to the bar 24 and includes a latch handle channel 28 that is configured to engage a latch handle 30 of the latch assembly 14. The first and second receivers 22, 26 are preferably constructed of molded plastic. The latch handle channel 28 may thus be an integral part of the second receiver 26.

One or both of the first receiver 22 and the second receiver 26 are selectively positionable relative to the bar 24 to adjust a length of the screen door crossbar. The first and second receivers 22, 26 may be secured to the bar 24 via a screw 32 or the like.

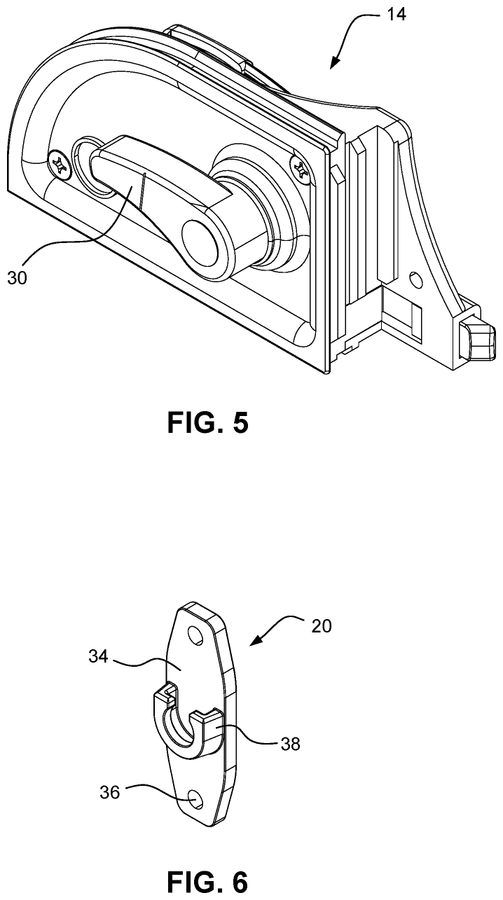

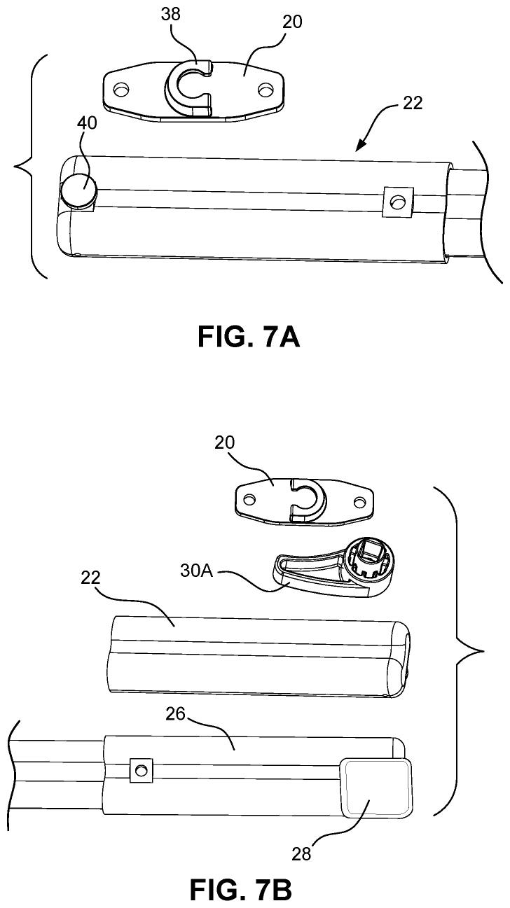

With reference to FIG. 6, the mounting bracket 20 includes a mounting plate 34 with openings 36 therein to receive a connector and a tab channel 38 coupled with the mounting plate 34. With reference to FIG. 7A, the first receiver 22 may be provided with a tab member 40 that is pivotally engageable with the tab channel 38. As shown, the tab member 40 is circular, and the tab channel 38 defines an at least part-circular receiving channel. With the tab member 40 secured in the tab channel 38, the first receiver 22 and bar 24 are rotatable, i.e., pivotable in the mounting bracket 20.

For an aftermarket installation, a replacement latch handle 30A (FIG. 7B) that is sized for cooperation with the second receiver 26 may be provided. That is, some existing configurations may include a latch handle that is too large for the latch receiving channel 28. In this instance, the user can replace the existing latch handle with the replacement latch handle 30A before installing the screen door crossbar according to the described embodiments. A line or other indicator may be included on the replacement latch handle 30A to indicate how far the latch receiver end of the crossbar should reach on the latch handle for optimal fit and movement.

In use, when an RV occupant pushes down on the bar 24, the bar 24 pivots on the tab member 40 engaged in the tab channel 38 to displace the latch handle 30 to a release position. The latch handle 30 is spring-biased to a lock position, and upon release of the bar 24, the spring-bias of the handle 30 displaces the handle and the bar 24 back to the latch position. In the embodiment shown in FIGS. 1 and 2, the assembly is shown with a Screen Shot® door closer available from Lippert Components that automatically closes the screen door once released from the RV door 10.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A screen door cross bar cooperable with a screen door assembly including a door frame and a latch assembly with a latch handle, the screen door cross bar comprising:
a mounting bracket securable to the door frame on a side of the door frame opposite from the latch assembly;
a first receiver pivotally attached to the mounting bracket;
a bar connected to the first receiver; and
a second receiver connected to the bar, the second receiver being configured to engage the latch handle.

2. A screen door cross bar according to claim 1, wherein at least one of the first receiver and the second receiver is selectively positionable relative to the bar to adjust a length of the screen door cross bar.

3. A screen door cross bar according to claim 2, wherein the at least one of the first receiver and the second receiver is secured to the bar with a screw.

4. A screen door cross bar according to claim 1, wherein the second receiver comprises a latch handle channel that is configured to receive the latch handle.

5. A screen door cross bar according to claim 4, wherein the second receiver is constructed of molded plastic, and wherein the latch handle channel is an integral part of the second receiver.

6. A screen door cross bar according to claim 1, wherein the mounting bracket comprises a mounting plate with openings therein to receive a connector and a tab channel coupled with the mounting plate.

7. A screen door cross bar according to claim 6, wherein the first receiver comprises a tab member that is pivotally engageable with the tab channel.

8. A screen door cross bar according to claim 7, wherein the tab member is at least partially circular, and wherein the tab channel defines an at least part-circular receiving channel.

9. A screen door cross bar according to claim 1, further comprising a replacement latch handle that is sized for cooperation with the second receiver.

10. A screen door cross bar cooperable with a screen door assembly including a door frame and a latch assembly with a latch handle, the screen door cross bar comprising:
a mounting bracket securable to the door frame on a side of the door frame opposite from the latch assembly; and
a bar pivotally attached at one end to the mounting bracket, the bar being configured to engage the latch handle at an opposite end.

11. A screen door cross bar according to claim 10, wherein a length of the bar is adjustable.

12. A screen door cross bar according to claim 11, further comprising a first receiver connected to and selectively positionable on the one end of the bar, the first receiver including a tab member that engages the mounting bracket.

13. A screen door cross bar according to claim 12, further comprising a second receiver connected to and selectively positionable on the opposite end of the bar, the second receiver engaging the latch handle.

14. A screen door cross bar according to claim 13, wherein the second receiver comprises a latch handle channel that is configured to receive the latch handle.

15. A screen door cross bar according to claim 14, wherein the second receiver is constructed of molded plastic, and wherein the latch handle channel is an integral part of the second receiver.

16. A screen door assembly comprising:
a door frame;
a screen material secured in the door frame;
a latch assembly including a latch handle; and
the screen door cross bar according to claim 10.

17. A method of installing a screen door cross bar on a screen door assembly including a door frame and a latch assembly with a latch handle, the method comprising:
(a) securing a mounting bracket to the door frame on a side of the door frame opposite from the latch assembly;
(b) engaging a handle end of a bar with the latch handle; and
(c) pivotally connecting a pivot end of the bar to the mounting bracket.

18. A method according to claim 17, wherein the screen door cross bar further includes a first receiver connected to the pivot end of the bar and a second receiver connected to a latch end of the bar, the method further comprising adjusting a length of the screen door cross bar by selectively positioning at least one of the first receiver and the second receiver on the bar.
